(19) United States
(12) Patent Application Publication
(10) Pub. No.: US 2022/0316638 A1
(43) Pub. Date: Oct. 6, 2022

(54) PRESS-FITTING PIPE CONNECTOR WITH TOOTHED RING

(71) Applicant: ZHEJIANG BANNINGER PIPING SYSTEM LTD., Yuhuan (CN)

(72) Inventors: Zhangfa YU, Yuhuan (CN); Haifeng CHEN, Yuhuan (CN); Guangbin SU, Yuhuan (CN); Hongsong ZHU, Yuhuan (CN)

(21) Appl. No.: 17/516,707

(22) Filed: Nov. 2, 2021

(30) Foreign Application Priority Data
Mar. 30, 2021 (CN) 202110336789.8

(51) Int. Cl. F16L 37/02; F16L 37/091

(52) U.S. Cl. CPC F16L 37/025; F16L 37/091

(57) ABSTRACT

The present invention provides a press-fitting pipe connector with a toothed ring, including a pipe joint, a sealing ring, a toothed clamping ring, a bushing and a pipe. The pipe joint is a “-”-like round pipe with equal wall thickness, the sealing ring, the toothed clamping ring, and the bushing are assembled in an inner cavity of the pipe joint, a fitting end of the pipe joint is run through inner cavities of the bushing, the toothed clamping ring and the sealing ring in sequence, a radial pressure is applied using a press-fitting tool along an outer diameter of the pipe joint, and both ends of the pipe joint are squeezed from a pipe shape into a neck shape under the action of the pressure. Therefore, the strength index and the safety requirements of the gas, fire-fighting and heat supply pipes of the high-rise buildings can be satisfied.

### CROSS REFERENCE TO THE RELATED APPLICATIONS

This application is based upon and claims priority to Chinese Patent Application No. 202110336789.8, filed on Mar. 30, 2021, the entire contents of which are incorporated herein by reference.

### TECHNICAL FIELD

The present invention relates to the field of pipe connector technologies, and in particular to a press-fitting pipe connector with a toothed ring.

### BACKGROUND

At present, along with continuous improvement of building technologies and effective increase of land utilization rate, more and more high-rise buildings appear in towns. The gas tanks have been replaced with the gas pipes. There exists a prominent problem that the conventional thin-walled press-fitting pipe connectors cannot reach a strength index of the high-rise buildings for gas, fire-fighting and heat supply pipes. Therefore, in order to ensure the safety of the gas, fire-fighting and heat supply pipes of the high-rise buildings in towns, it is urgent to develop an up-to-standard, safe and reliable press-fitting pipe connector.

### SUMMARY

In order to ensure strength index and safety requirements of gas, fire-fighting and heat supply pipes of high-rise buildings in towns, the present invention provides a press-fitting pipe connector with a toothed ring. An ordinary thick-walled steel pipe is machined into a pipe pre-form which is then extruded into a pipe joint, and a sealing ring, a toothed clamping ring and a bushing are disposed in an inner cavity of the pipe joint. During mounting, a pipe is inserted into inner diameters of the sealing ring, the toothed clamping ring and the bushing assembled in the inner cavity of the pipe joint, a radial pressure is applied using a press-fitting tool along an outer diameter of the pipe joint, and both ends of the pipe joint are squeezed from a pipe shape into a neck shape under the action of the pressure. The sealing ring tightly seals up a gap between an inner diameter of the pipe joint and an outer diameter of the pipe, and ratchets disposed on the toothed clamping ring are closely engaged with the outer diameter of the pipe. Thus, an anti-drawing strength is greatly increased. The anti-drawing strength generated using the toothed sealing ring, the toothed clamping ring and the bushing is 1.5-2.5 times that generated using the sealing ring alone. Therefore, the strength index and the safety requirements of the gas, fire-fighting and heat supply pipes of the high-rise buildings can be satisfied.

In order to achieve the above object, the present invention employs the following technical solution: provided is a press-fitting pipe connector with a toothed ring, comprising a pipe joint 1, a sealing ring 2, and a pipe 5. The pipe joint 1 is a “-”-like round pipe with equal wall thickness, an annular groove segment 1a is disposed in a middle portion of the pipe joint 1, a conical pipe 1b, a round pipe segment 1c, a sealing ring protrusion ring segment 1d and a shrinking clamping mouth if are disposed at both ends of the annular groove segment 1a in sequence, a protrusion ring assembly segment 1e for assembling a toothed clamping ring 3 and a bushing 4 is added between the sealing ring protrusion ring segment 1d and the shrinking clamping mouth 1f, a sealing ring 2, the toothed clamping ring 3 and the bushing 4 are assembled in parallel in inner cavities of the sealing ring protrusion ring segment 1d and the protrusion ring assembly segment 1e of the toothed clamping ring 3 and the bushing 4, a fitting end of the pipe 5 is run through inner diameters of the shrinking clamping mouth 1f, the bushing 4, the toothed clamping ring 3, the sealing ring 2, the round pipe segment 1c and the conical pipe 1b to the annular groove segment 1a, a radial pressure is applied by a press-fitting tool along outer diameters of the round pipe segment 1c, the sealing ring protrusion ring segment 1d and the protrusion ring assembly segment 1e of the toothed clamping ring 3 and the bushing 4, and the round pipe segment 1c, the sealing ring protrusion ring segment 1d and the protrusion ring assembly segment 1e of the toothed clamping ring 3 and the bushing 4 change from a round pipe shape into a neck shape under the action of the pressure.

An outer diameter of the sealing ring 2 is in a half-moon shape, an inner diameter of the sealing ring 2 is in a “-”-like sawtooth shape 2a, the outer diameter of the sealing ring 2 is matched with the inner cavity of the sealing ring protrusion ring segment 1d, and the “-”-like sawtooth shape 2a of the inner diameter of the sealing ring 2 is matched with the pipe 5.

The toothed clamping ring 3 is provided with ratchets 3a which are staggeredly arranged along an inner circle of the toothed clamping ring 3.

The pipe joint 1 has a diameter of from DN15 to DN100 and comprises any one of a straight pipe joint, a bend pipe joint, a three-way pipe joint, and a press-fitting crossover joint.

The working principle of the present invention is as follows: an ordinary thick-walled steel pipe is machined into a pipe pre-form which is then extruded into a pipe joint, and a sealing ring, a toothed clamping ring and a bushing are disposed in an inner cavity of the pipe joint. During mounting, a pipe is inserted into inner diameters of the sealing ring, the toothed clamping ring and the bushing assembled in the inner cavity of the pipe joint, a radial pressure is applied using a press-fitting tool along an outer diameter of the pipe joint, and both ends of the pipe joint are squeezed from a pipe shape into a neck shape under the action of the pressure. The sealing ring tightly seals up a gap between an inner diameter of the pipe joint and an outer diameter of the pipe, and ratchets disposed on the toothed clamping ring are closely engaged with the outer diameter of the pipe. Thus, an anti-drawing strength is greatly increased. Therefore, the strength index and the safety requirements of the gas, fire-fighting and heat supply pipes of the high-rise buildings can be satisfied. The pipe joint has a diameter of from DN15 to DN100 and comprises one of straight pipe joint, bend pipe joint, three-way pipe joint, and press-fitting crossover joint.

The present invention has the following beneficial effects. In the above construction, an ordinary thick-walled steel pipe is machined into a pipe pre-form which is then extruded into a pipe joint, and a sealing ring, a toothed clamping ring and a bushing are disposed in an inner cavity of the pipe joint. During mounting, a pipe is inserted into inner diameters of the sealing ring, the toothed clamping ring and the bushing assembled in the inner cavity of the pipe joint, a radial pressure is applied using a press-fitting tool along an outer diameter of the pipe joint, and both ends of the pipe joint are squeezed from a pipe shape into a neck shape under the action of the pressure. The sealing ring tightly seals up a gap between an inner diameter of the pipe joint and an outer diameter of the pipe, and ratchets disposed on the toothed clamping ring are closely engaged with the outer diameter of the pipe. Thus, an anti-drawing strength is greatly increased. The anti-drawing strength generated using the toothed sealing ring, the toothed clamping ring and the bushing is 1.5-2.5 times that generated using the sealing ring alone. Generally, a minimum anti-pull resistance generated after a DN32 thin-walled press-fitting steel pipe and a pipe fitting are connected is 6.42 kN while an anti-pull resistance generated using the toothed sealing ring, the toothed clamping ring and the bushing can reach 12.06 kN. It can be seen that the addition of the toothed sealing ring, the toothed clamping ring and the bushing increases the anti-pull resistance, thus avoiding impact of sewage and rainwater erosions and satisfying the pressure-resistant strength and the safety requirements of the gas, fire-fighting and heat supply pipes of the high-rise buildings. The pipe joint has a diameter of from DN15 to DN100 and comprises any one of a straight pipe joint, a bend pipe joint, a three-way pipe joint, and a press-fitting crossover joint.

### BRIEF DESCRIPTIONS OF THE DRAWINGS

FIG. 1 is a structural schematic diagram of a press-fitting pipe connector with a toothed ring.

FIG. 2 is a structural schematic diagram of a pipe joint of a press-fitting pipe connector with a toothed ring.

FIG. 3 is a structural schematic diagram of a sealing ring of a press-fitting pipe connector with a toothed ring.

FIG. 4 is a structural schematic diagram of a toothed clamping ring of a press-fitting pipe connector with a toothed ring.

FIG. 5 is a structural schematic diagram of a bushing of a press-fitting pipe connector with a toothed ring.

Numerals of the drawings are described below: 1. pipe joint, 1a. annular groove segment, 1b. conical pipe, 1c. round pipe segment, 1d. sealing ring protrusion ring segment, 1e. protrusion ring assembly segment of toothed clamping ring 3 and bushing 4, 1f. shrinking clamping mouth, 2. sealing ring, 2a. “-”-like sawtooth shape, 3. toothed clamping ring, 3a. ratchet, 4. bushing, and 5. pipe.

### DETAILED DESCRIPTIONS OF EMBODIMENTS

The accompanying drawings of the present invention show some preferred embodiments of the present invention. A press-fitting pipe connector with a toothed ring according to the present invention will be further described below in combination with the accompanying drawings.

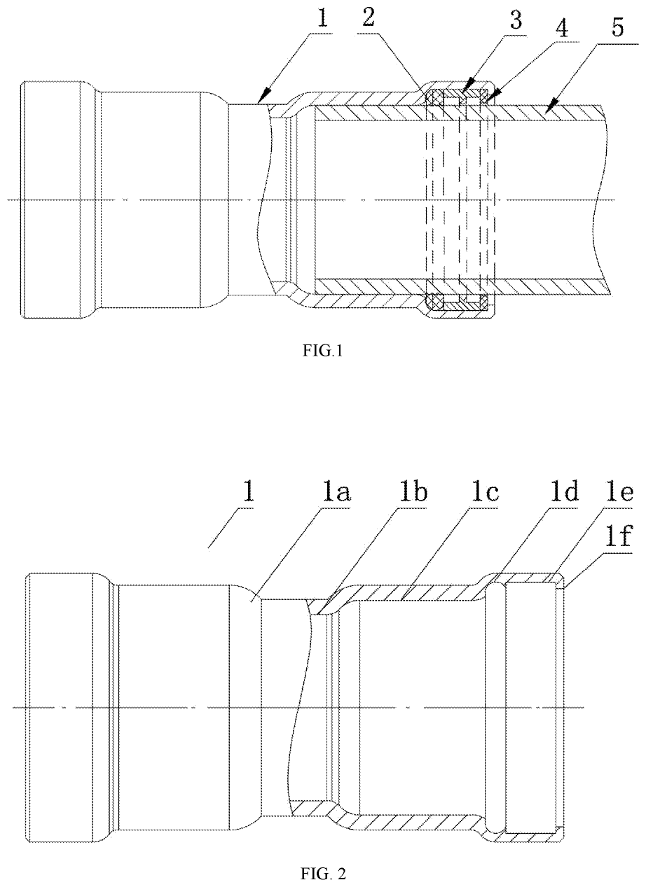

As shown in FIGS. 1-2, the present invention provides a press-fitting pipe connector with a toothed ring, comprising a pipe joint 1, a sealing ring 2, a toothed clamping ring 3, a bushing 4, and a pipe 5. The pipe joint 1 is a “-”-like round pipe with equal wall thickness, an annular groove segment 1a is disposed in a middle portion of the pipe joint 1, a conical pipe 1b, a round pipe segment 1c, a sealing ring protrusion ring segment 1d, a protrusion ring assembly segment 1e of the toothed clamping ring 3 and the bushing 4, and a shrinking clamping mouth if are disposed at both ends of the annular groove segment 1a in sequence, the sealing ring 2, the toothed clamping ring 3 and the bushing 4 are assembled in parallel in inner cavities of the sealing ring protrusion ring segment 1d and the protrusion ring assembly segment 1e of the toothed clamping ring 3 and the bushing 4, a fitting end of the pipe 5 is run through inner diameters of the shrinking clamping mouth 1f, the bushing 4, the toothed clamping ring 3, the sealing ring 2, the round pipe segment 1c and the conical pipe 1b to the annular groove segment 1a, a radial pressure is applied by a press-fitting tool along outer diameters of the round pipe segment 1c, the sealing ring protrusion ring segment 1d and the protrusion ring assembly segment 1e of the toothed clamping ring 3 and the bushing 4, and the round pipe segment 1c, the sealing ring protrusion ring segment 1d and the protrusion ring assembly segment 1e of the toothed clamping ring 3 and the bushing 4 change from a round pipe shape into a neck shape under the action of the pressure.

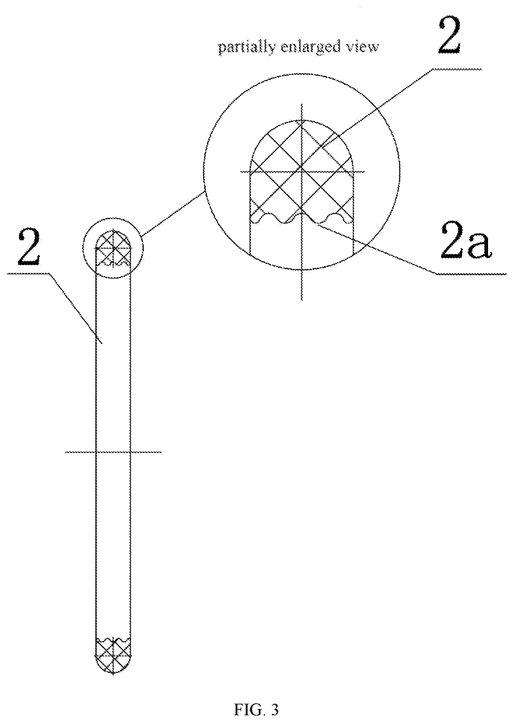

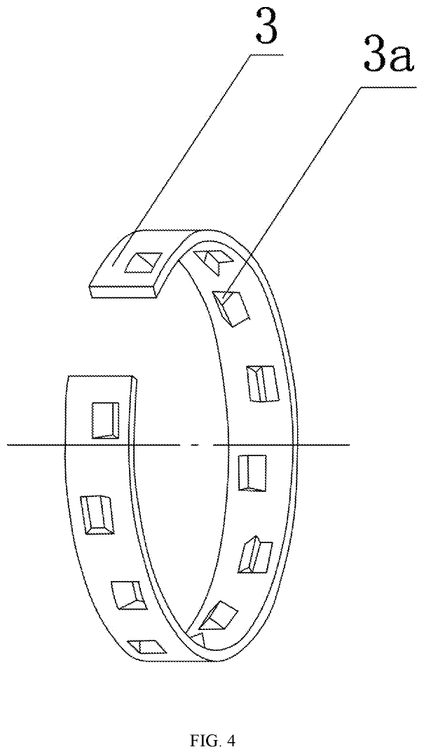

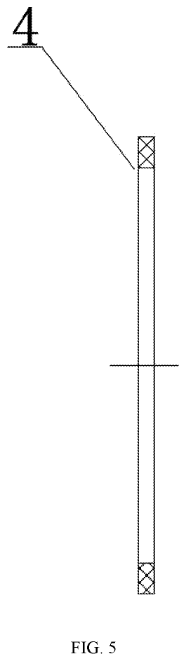

As shown in FIG. 3, an outer diameter of the sealing ring 2 is in a half-moon shape, an inner diameter of the sealing ring 2 is in a “-”-like sawtooth shape 2a, the outer diameter of the sealing ring 2 is matched with the inner cavity of the sealing ring protrusion ring segment 1d, and the “-”-like sawtooth shape 2a of the inner diameter of the sealing ring 2 is matched with the pipe 5.

As shown in FIG. 4, the toothed clamping ring 3 is provided with ratchets 3a which are staggeredly arranged along an inner circle of the toothed clamping ring 3.

The working principle of the present invention is as follows: an ordinary thick-walled steel pipe is machined into a pipe pre-form which is then extruded into a pipe joint, and a sealing ring, a toothed clamping ring and a bushing are disposed in an inner cavity of the pipe joint. During mounting, a pipe is inserted into inner diameters of the sealing ring, the toothed clamping ring and the bushing assembled in the inner cavity of the pipe joint, a radial pressure is applied using a press-fitting tool along an outer diameter of the pipe joint, and both ends of the pipe joint are squeezed from a pipe shape into a neck shape under the action of the pressure. The sealing ring tightly seals up a gap between an inner diameter of the pipe joint and an outer diameter of the pipe, and ratchets disposed on the toothed clamping ring are closely engaged with the outer diameter of the pipe. Thus, an anti-drawing strength is greatly increased. Therefore, the strength index and the safety requirements of the gas, fire-fighting and heat supply pipes of the high-rise buildings can be satisfied. The pipe joint has a diameter of from DN15 to DN100 and comprises one of straight pipe joint, bend pipe joint, three-way pipe joint, and press-fitting crossover joint.

The above descriptions of the present invention are merely illustrative rather than limiting. Many modifications, changes, or equivalents made by those skilled in the art without departing from the spirit and scope of the appended claims shall all fall within the scope of protection of the present invention.

What is claimed is:

1. A press-fitting pipe connector with a toothed ring, comprising: a pipe joint (1), a sealing ring (2) and a pipe (5), wherein the pipe joint (1) is a “-”-like round pipe with equal wall thickness, an annular groove segment (1a) is disposed in a middle portion of the pipe joint (1), a conical pipe (1b), a round pipe segment (1c), a sealing ring protrusion ring segment (1d) and a shrinking clamping mouth (1f) are disposed at both ends of the annular groove segment (1a) in sequence, a protrusion ring assembly segment (1e) for assembling a toothed clamping ring (3) and a bushing (4) is added between the sealing ring protrusion ring segment (1d) and the shrinking clamping mouth (1f), a sealing ring (2), the toothed clamping ring (3) and the bushing (4) are assembled in parallel in inner cavities of the sealing ring protrusion ring segment (1d) and the protrusion ring assembly segment (1e) of the toothed clamping ring (3) and the bushing (4), a fitting end of the pipe (5) is run through inner diameters of the shrinking clamping mouth (1f), the bushing (4), the toothed clamping ring (3), the sealing ring (2), the round pipe segment (1c) and the conical pipe (1b) to the annular groove segment (1a), a radial pressure is applied by a press-fitting tool along outer diameters of the round pipe segment (1c), the sealing ring protrusion ring segment (1d) and the protrusion ring assembly segment (1e) of the toothed clamping ring (3) and the bushing (4), and the round pipe segment (1c), the sealing ring protrusion ring segment (1d) and the protrusion ring assembly segment (1e) of the toothed clamping ring (3) and the bushing (4) change from a round pipe shape into a neck shape under the action of the pressure.

2. The press-fitting pipe connector of claim 1, wherein an outer diameter of the sealing ring (2) is in a half-moon shape, an inner diameter of the sealing ring (2) is in a “-”-like sawtooth shape (2a), the outer diameter of the sealing ring (2) is matched with the inner cavity of the sealing ring protrusion ring segment (1d), and the “-”-like sawtooth shape (2a) of the inner diameter of the sealing ring (2) is matched with the pipe (5).

3. The press-fitting pipe connector of claim 1, wherein the toothed clamping ring (3) is provided with ratchets (3a) which are staggeredly arranged along an inner circle of the toothed clamping ring (3).

4. The press-fitting pipe connector of claim 1, wherein the pipe joint (1) has a diameter of from DN15 to DN100 and comprises one of straight pipe joint, bend pipe joint, three-way pipe joint, and press-fitting crossover joint.
